(19) United States
(12) Patent Application Publication
(10) Pub. No.: US 2014/0116415 A1
(43) Pub. Date: May 1, 2014

(54) GRIDDLE TABLE WITH HEAT DEFLECTOR SYSTEM

(71) Applicant: Andreas Birke, Islamorada, FL (US)

(72) Inventor: Andreas Birke, Islamorada, FL (US)

(21) Appl. No.: 14/066,466

(22) Filed: Oct. 29, 2013

Related U.S. Application Data
(60) Provisional application No. 61/720,002, filed on Oct. 30, 2012.

(51) Int. Cl. A47J 37/06; A47B 37/00

(52) U.S. Cl. CPC A47J 37/0682; A47B 37/00
USPC 126/37 A; 99/422; 126/39 H

(57) ABSTRACT

A teppanyaki style gas flame heated griddle table having a heat deflector disposed beneath the griddle plate for directing heat radiating from underneath the griddle plate upward and through an exhaust channel between a counter and a top side of the griddle plate for directing the heated air back across the grilling surface on a top side of the griddle plate and away from persons seated around the table.

### BACKGROUND OF THE INVENTION

1) Field of the Invention

The present invention relates to heated flat surface griddles, and more particularly, to a teppanyaki style gas flame heated griddle table having a heat deflector system for directing heat radiating laterally outward from underneath the grilling surface back across the grilling surface and away from persons seated around the table.

2) Description of Related Art

Teppanyaki traditionally refers to a type of Japanese cooking style that utilizes a large flat steel griddle surface heated from underneath by a gas flame. The teppanyaki style of cooking was introduced in the United States of America in the mid 1960's and has continued in popularity ever since.

In a typical embodiment, the griddle surface is partially or completely surrounded by a counter at which dinners eat food cooked on the griddle. Depending on the style of table, various side paneling encloses most if not all of the supporting structure for the griddle surface to prevent direct exposure of the dinners to the gas flame. In particular with enclosed table designs, radiating heat can cause the side panels to heat up and/or escape from various openings around the paneling, causing discomfort for the dinners.

Accordingly, it is an object of the present invention to provide a teppanyaki style griddle table in which dinners around the table are shielded from radiating heat.

It is a further object of the present invention to redirect excess radiating heat underneath the griddle plate across the upper surface of the plate to facilitate cooking.

### SUMMARY OF THE INVENTION

The above objectives are accomplished according to the present invention by providing a griddle table comprising a support base defined by a plurality of connected frame members; a griddle plate carried by said support base; a counter carried by said support base, wherein said counter extends over top of a perimeter portion of a top side of said griddle plate, and wherein said counter is spaced above said top side of said griddle plate defining an exhaust channel between said top side of said griddle plate and a bottom side of said counter overlapping said perimeter portion of said griddle plate; a burner unit carried by said support base disposed beneath said griddle plate for applying heat to a bottom side of said griddle plate; and, a heat deflector carried by said support base disposed beneath and spaced apart from said griddle plate that extends upward and engages said bottom side of said counter for directing heated air into said exhaust channel; whereby heated air is directed upward from underneath said griddle plate by said heat deflector and out through said exhaust channel for directing said heated air across said top side of said griddle plate.

In a further embodiment, the griddle table includes a floor plate carried by said support base, wherein said floor plate includes a plurality of openings to promote airflow up and through said support base to exit said exhaust channel.

In a further embodiment, the griddle table includes a plurality of leveling bolts carried by said support base engaging said griddle plate, wherein said leveling bolts are adjustable for varying the height at which said leveling bolts project from said support base for engaging said griddle plate to adjust the level of said griddle plate on said support base and control the size of said exhaust channel between said counter and griddle plate.

In a further embodiment, the griddle table includes a bolt recess disposed in a head of each of said leveling bolts, and a plurality of retainer prongs projecting downward from said bottom side of said griddle plate, wherein each of said retainer prongs is received into a complementary shaped bolt recess of said leveling bolts so that said griddle plate is releasably secured on said support base.

In a further embodiment, the counter is pivotally connected to said support base for operating between a lowered position adjacent and extending overtop of said perimeter portion of said griddle plate, and a raised position allowing accessing to and removal of said griddle plate from said support base.

In a further embodiment, the griddle table includes a securing bracket releasably securing said counter to said support base to control pivotal operation of said counter between said raised and lowered positions.

In a further embodiment, the securing bracket includes a securing arm carried by said support base, and a complementary arm receiving member carried by said counter, wherein said securing arm is received into said arm receiving member for securing said counter to said support base.

In a further embodiment, the griddle table includes a locking pin extending through a continuous opening defined in said securing arm and said arm receiving member, wherein said locking pin is removable to allow separation of said securing arm from said arm receiving member to operate said counter between said raised and lowered positions.

In a further embodiment, the griddle table includes a pneumatic assistant cylinder mechanism interconnecting said counter and said support base to facilitate raising and lower of said counter.

In a further embodiment, the counter fully surrounds said griddle plate for accommodating seating on all sides.

In a further embodiment, the griddle table includes a heat shield disposed on said bottom side of counter along at least the portion of said counter that overlaps above said perimeter portion of said griddle plate to protect the adjacent surface of said counter from heat radiated from griddle plate 12 and passing through said exhaust channel.

In a further embodiment, the griddle table includes a series of panel members surround support base 10 for containing and channeling heat radiating from said burner unit and said bottom side of said griddle plate upward and out said exhaust channel.

In a further embodiment, the heat deflector includes an arrangement of upper heat trays and lower heat trays carried adjacent each other on said support base and extending laterally underneath said griddle plate for channeling radiating heat upward and around said griddle plate and out through said exhaust channel across a top side of said griddle plate.

In a further embodiment, the lower heat trays are angled upwardly toward said perimeter portion of said griddle plate for channeling radiating heat toward said exhaust channel.

In a further embodiment, the upper heat trays extend generally from said lower heat trays upward to engage said bottom side of said counter so that radiating heat is directed into said exhaust channel.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows perspective view of the griddle table according to the present invention;

FIG. 2 shows a top view of the griddle table according to the present invention;

FIG. 3 shows a cut-away top view of the griddle table according to the present invention;

FIG. 4 shows a side cross-section view of the griddle table according to the present invention;

FIG. 5 shows a perspective view of the support frame of the griddle table according to the present invention;

FIG. 6A shows a details cross-section view of a portion of the support frame of the griddle table according to the present invention;

FIG. 6B shows a perspective partial exploded view of the griddle table according to the present invention;

FIG. 7 shows a perspective partial exploded view of the griddle table according to the present invention;

FIG. 8 shows a perspective partial exploded view of the griddle table according to the present invention;

FIG. 9 shows a perspective view of the counter and heat shield operable between a raised and lowered position according to the present invention;

FIGS. 10A-10C show perspective views of the upper heat deflector trays according to the present invention;

FIG. 11 shows a perspective view of a lower heat deflector tray according to the present invention;

FIG. 12 shows a side view of the overlap arrangement between adjacent lower heat deflector trays according to the present invention;

FIG. 13 shows a perspective view of a leg panel of the griddle table according to the present invention;

FIG. 14 shows an exploded perspective view of a side panel and panel support footing according to the present invention;

FIG. 15 shows an exploded perspective view of a leveling bolt and griddle plate retainer prong according to the present invention;

FIG. 16 shows a perspective view of a hinge carried by the support frame for moving the counter and heat shield between a raised and lowered position;

FIG. 17 shows a perspective view of a securing bracket for securing the counter to the support frame;

FIG. 18 shows a cross-section view of the leveling bolt and griddle plate retainer prong according to the present invention; and,

FIG. 19 shows a detailed cross-section view of an upper portion of the griddle table illustrating the control of heat radiating from underneath the griddle plate according to the present invention.

It will be understood by those skilled in the art that one or more aspects of this invention can meet certain objectives, while one or more other aspects can meet certain other objectives. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to specific embodiments, it will be appreciated that the description is illustrative of the invention and is not constructed as limiting of the invention. Various modifications and applications may occur to those who are skilled in the art, without departing from the spirit and the scope of the invention.

### DETAILED DESCRIPTION OF A PREFERRED EMBODIMENT

With reference to the drawings, the invention will now be described in more detail.

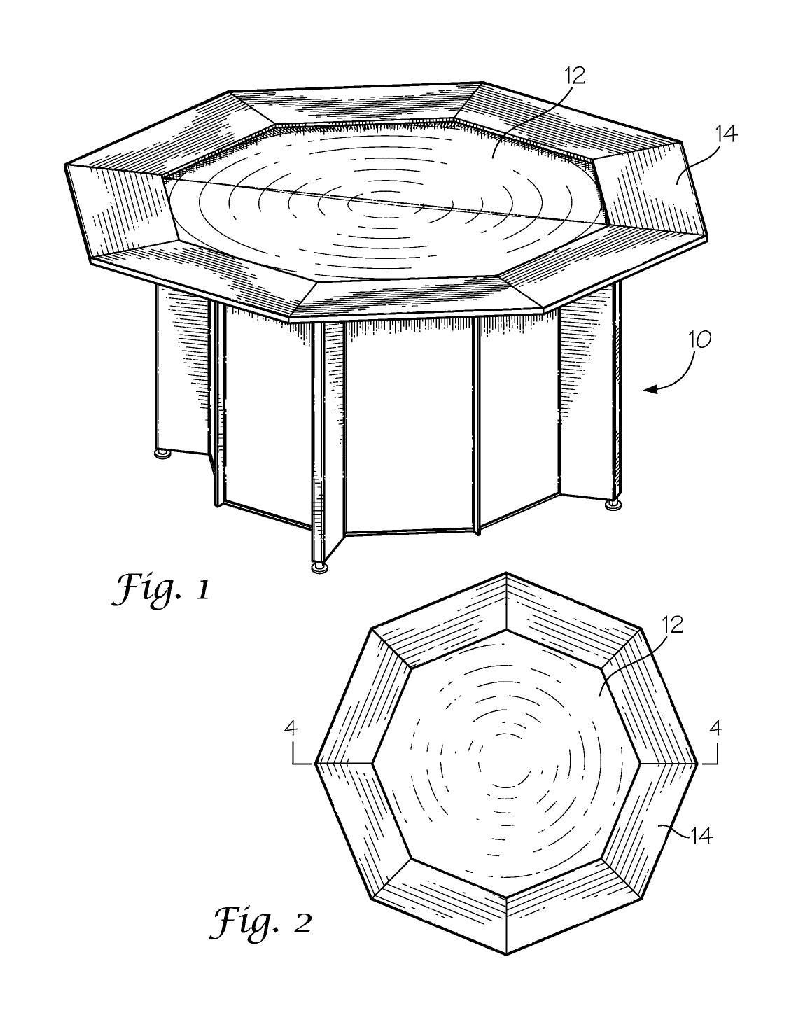

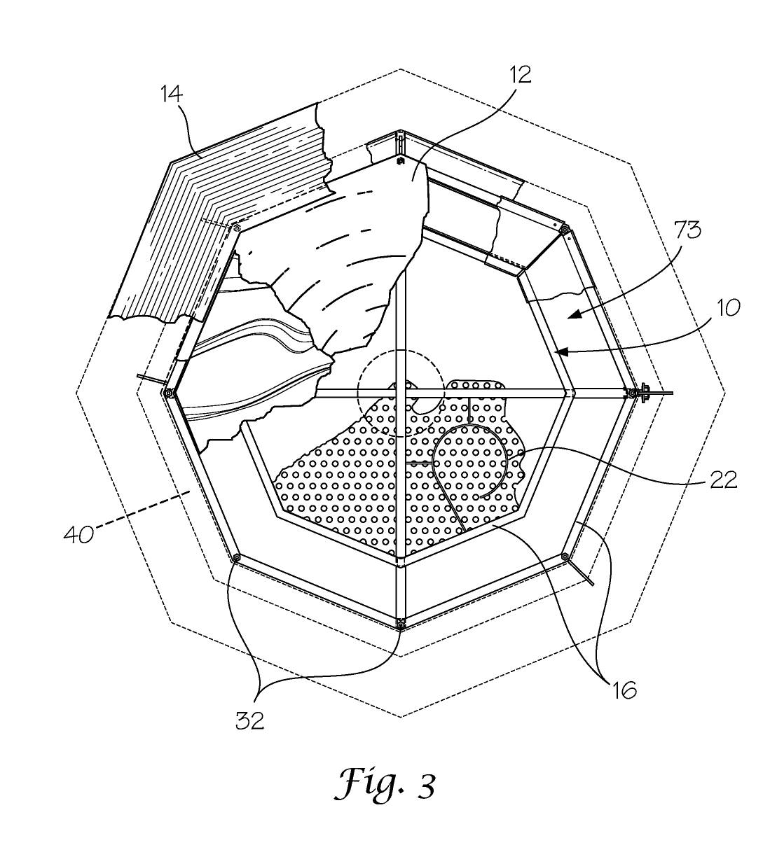

Referring to FIGS. 1-3, a teppanyaki style griddle table is shown in the illustrated embodiment having a support base, designated generally as 10, a griddle plate 12 carried on top of support base 10, and a counter 14 surrounding griddle plate 12.

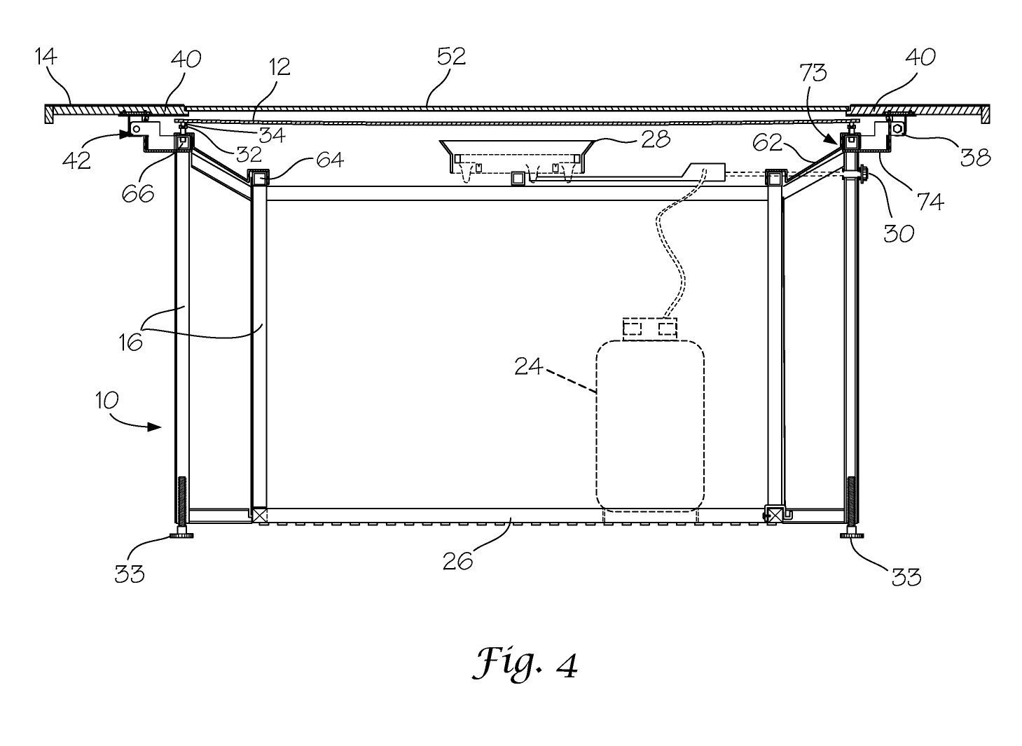

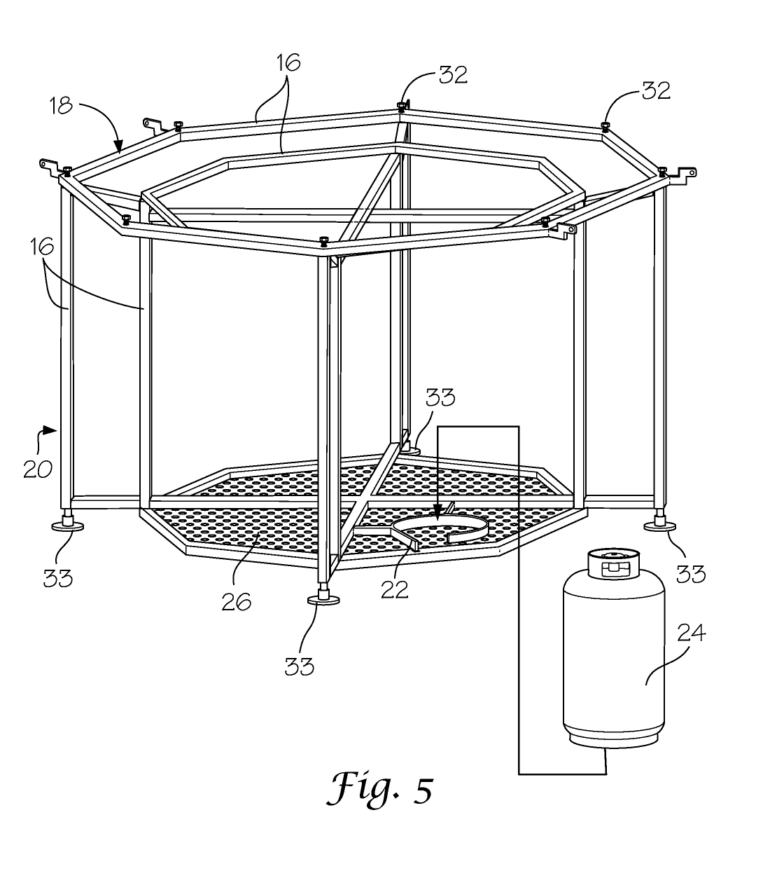

Referring to FIGS. 4 and 5, support base 10 includes a plurality of internal frame members 16 which define an upper portion 18 constructed and arranged in an octagonal shape to carry griddle plate 12, and a lower portion 20 for supporting various side panels. In one embodiment, frame members 16 are made of square 1″×1″×16 gauge T316 stainless steel tubing. A plurality of adjustable foot members 33 are rotatably carried by frame members 16 for leveling the griddle table.

In the illustrated embodiment, a securing bracket 22 is provided for holding a propane tank 24 on floor plate 26. Floor plate 26 includes a plurality of openings to promote airflow up and though support base 10.

A burner unit 28 is carried in the upper portion 18 and operatively connected to propane tank 24 for providing a gas flame to a bottom side of griddle plate 12. A control member 30 is operatively connected to burner unit 28 for controlling flame operation. In the preferred embodiment, burner unit 28 is a 32000 BTU burner powered by LP (liquid propane) stored in propane tank 24 of support base 10.

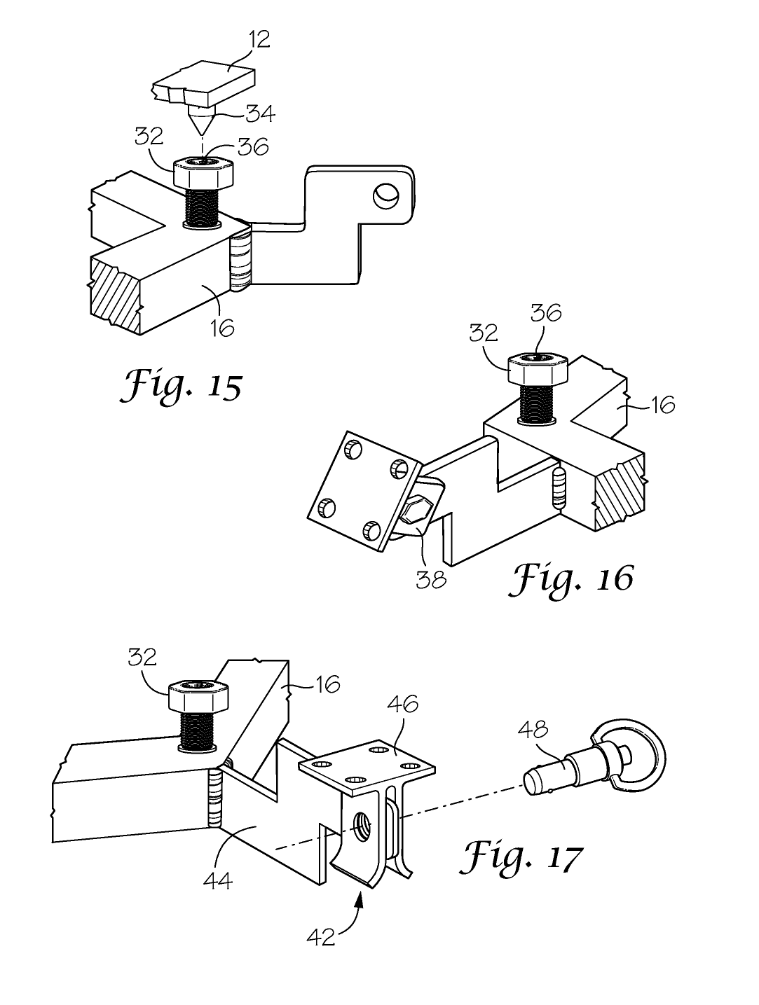

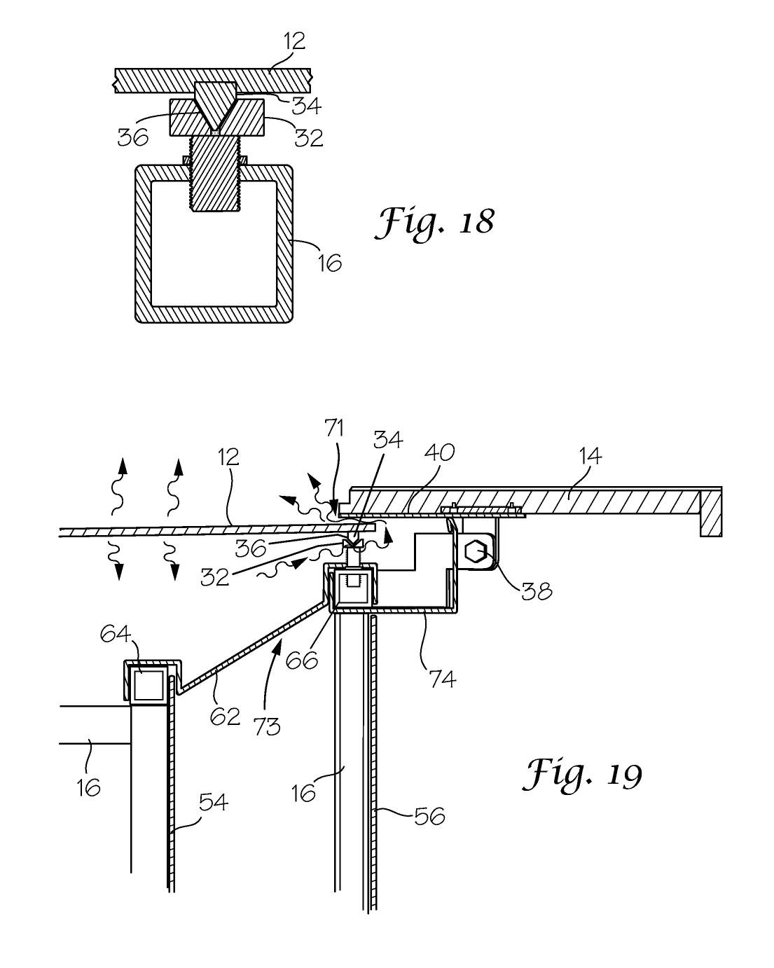

Referring to FIGS. 4, 5, 15 and 18-19, a plurality of leveling bolts 32 are carried by upper portion 18 of internal frame members 16. Each of leveling bolts 32 cooperates with frame members 16 through a threaded screw-in connection so that each of leveling bolts 32 can be rotated to extend a desired height above frame members 16. A bolt recess 36 is disposed in the head of each leveling bolt. Griddle plate 12 includes a plurality of retainer prongs 34 projecting downward from a bottom side. Each of retainer prongs 34 is received into a complementary shaped bolt recess 36 of leveling bolts 32 in a friction fit arrangement. Accordingly, griddle plate 12 can be leveled and secured in place on upper portion 18 of frame members 16. By adjusting leveling bolts 32, the spacing of griddle plate 12 between frame members 16 of support base 10 and a bottoms side of counter 14, heat radiating out of an exhaust channel 71 between griddle plate 12 and the bottom side of counter 14 can be controlled and varied.

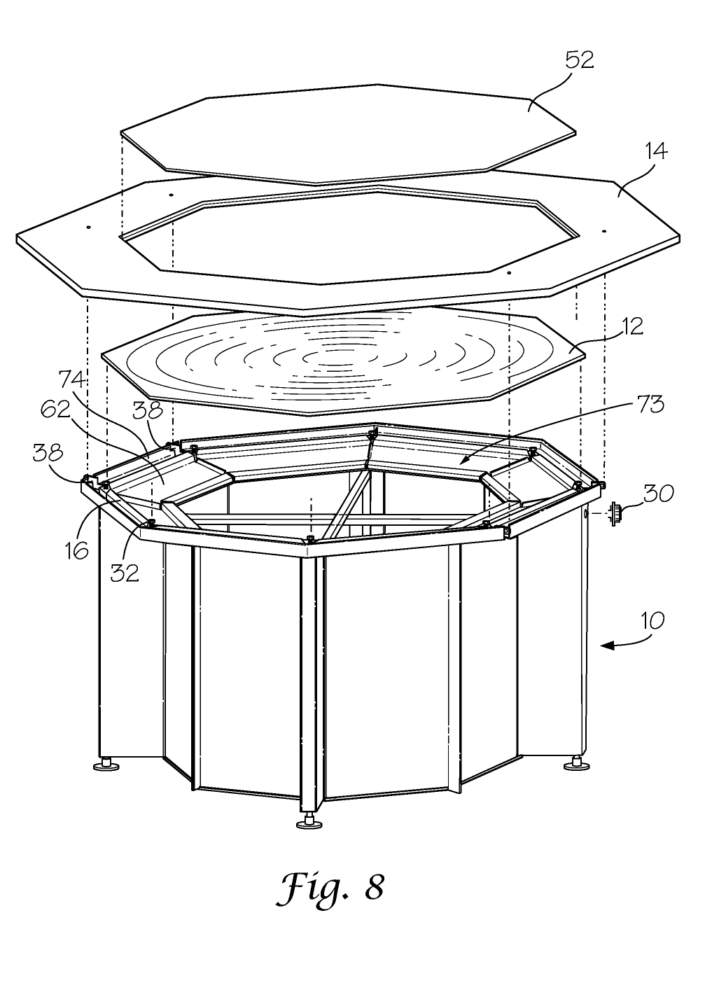

Referring to FIG. 8, in the illustrated embodiment, griddle plate 12 is an octagonal concaved cooking surface made of hospital grade mirror image polished T316 stainless steel and is the perfect choice for all different kinds of simple every day or gourmet cooking. It is Ideal for areas that are subject to high moisture and everyday cleaning, which makes it the perfect surface for private homes or commercial businesses. T316 stainless steel has a tough surface that can handle water, heat, and general mistreatment that won't rust or get damaged due to humidity and moisture. It is unaffected by a wide range of chemicals, easy to clean and sanitize after cooking.

Referring to FIGS. 8, 9, 16-17 and 19, in the illustrated embodiment, counter 14 is preferably a wood octagonal shaped service table. In the exemplary embodiment, this allows for seating on all sides. This arrangement is by way of example only, and is not limiting of the present invention. Various shapes and arrangements may be provided without deporting from the spirit and scope of the present invention. Preferably, counter 14 is made of reinforced 1½″ thick furniture grade laminate wood and can be topped with fine wood veneer or made out of solid wood or different materials like: stone, stainless steel, carbon fiber, glass and many more materials commonly used by those skilled in the art of furniture making.

Counter 14 is carried on upper portion 18 of frame members 16 by a pair of hinges 38. Counter 14 is operable between a lowered position adjacent griddle plate 12 and a raised position to allow for removal and cleaning of griddle plate 12. To prevent unwanted movement between the raised and lowered positions, a pair of securing brackets (designated generally as 42) are provided to lock counter 14 to frame members 16. A single securing bracket 42 may alternatively be sufficient. As best shown in FIG. 17, each securing bracket 42 includes a securing arm 44 extending laterally from frame member 16, and a complementary arm receiving member 46 carried by counter 14. A locking pin 48 is removable inserted though a continuous opening defined by securing arm 44 and arm receiving member 46 to lock counter 14 to frame members 16. By simply removing the pin, counter 14 can be raised.

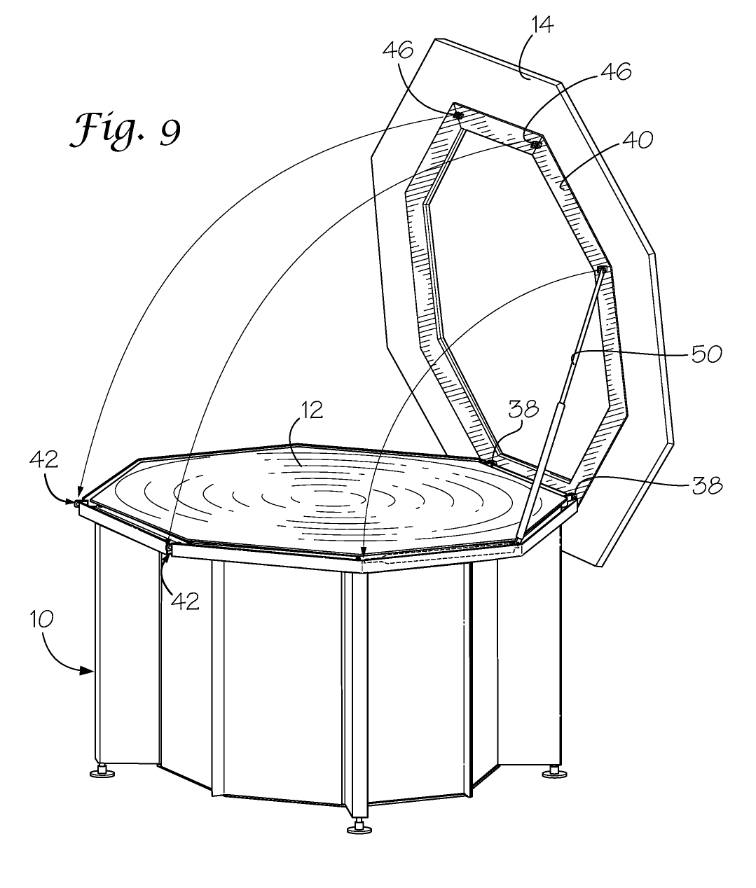

As shown in FIG. 9, a pneumatic assistant cylinder mechanism 50 is provided which interconnects counter 14 to a frame member 16 to help lift/tilt counter 14 to access griddle plate 12 and the heat deflector trays for easy cleaning.

In the lowered position (FIG. 4), counter 14 overlaps above a perimeter portion of a top side of griddle plate 12. To protect the adjacent surface of counter 14 from heat radiated from griddle plate 12 and passing through said exhaust channel 71, a heat shield 40 is disposed on a bottom side of counter 14 along at least the portion of counter 14 that overlaps above griddle plate 12.

When griddle plate 12 is not in use, a cover insert 52 can be placed over top of griddle plate 12 and carried by counter 14.

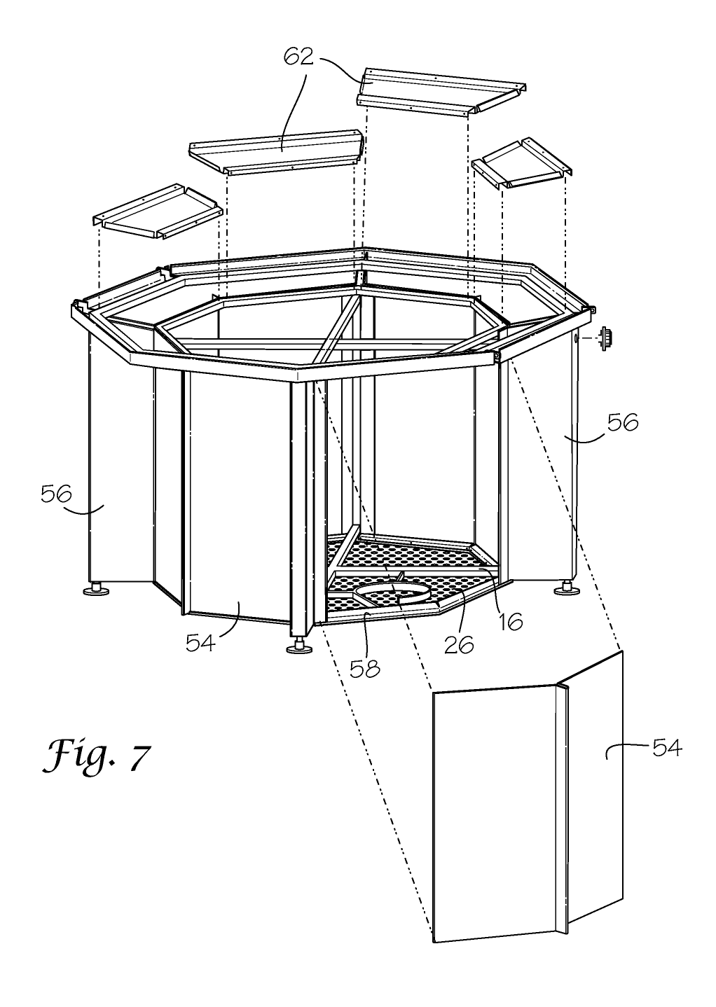

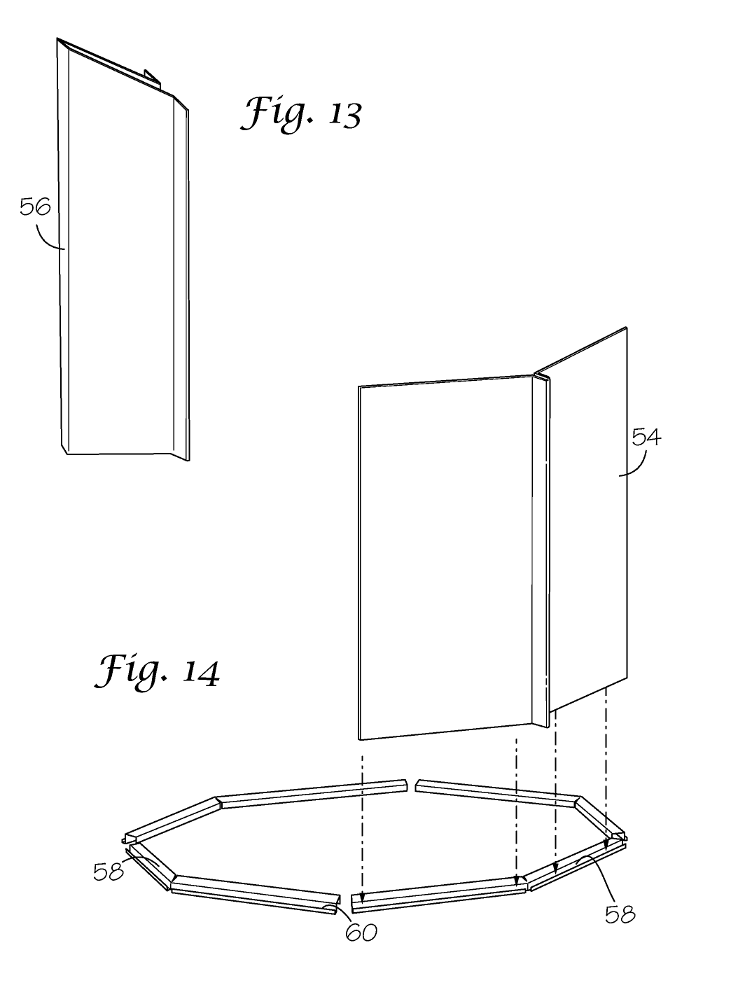

Referring to FIGS. 7, 13 and 14, surrounding internal frame members 16 around lower portion 20 of support base 10 are a series of panel members for helping to contain heat radiating from burner unit 28 and the bottom side of griddle plate 12 and channeling the heated air upward from floor plate 26 and out exhaust channel 71. In the illustrate embodiment, panel members including side panels 54 and leg panels 56. The side and leg panels 54, 56 are carried by a series of panel support members 58 disposed adjacent floor plate 26 on frame members 16. The side and leg panels 54, 56 are received into a channel 60 of panel support members 58 in a simple up/down locking system to hold the panels in position against frame members 16. In a preferred embodiment, paneling is constructed of 22 gauges T316 stainless steel for durability.

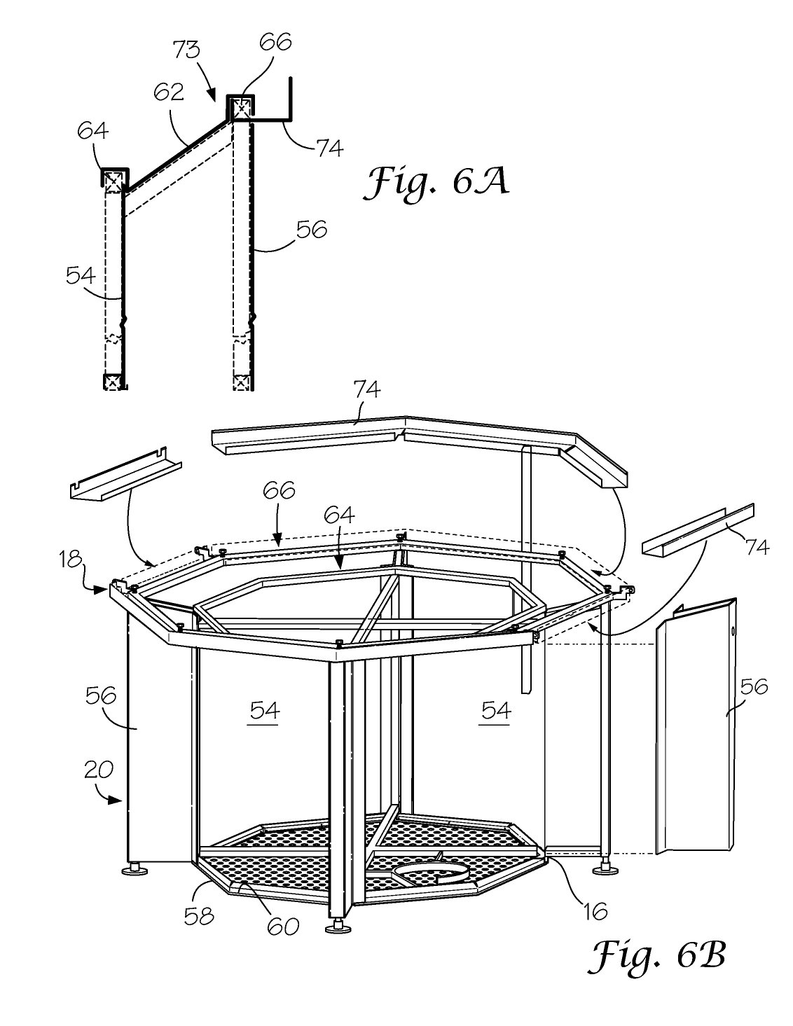

Referring to FIGS. 6A-7 and 10A-12 and 19, a unique heat deflecting system is carried by internal frame members 16 in upper portion 18 so that it can deflect the heated air radiating outward from burner 28 back onto the cooking surface, and away from guests sitting at the table. As best shown in FIG. 19, the heat radiating underneath griddle plate 12 gets channeled upward by a heat deflector, designated generally as 73, which is defined by an arrangement of upper and lower heat trays 62, 74 and out from underneath griddle plate 12 through a gap defining exhaust channel 71 between a bottom side of counter 14 and a top side of griddle plate 12, towards the center of griddle plate 12. In a preferred embodiment, exhaust channel 71 is approximately a ⅛″ gap between griddle plate 12 and the bottom side of counter 14.

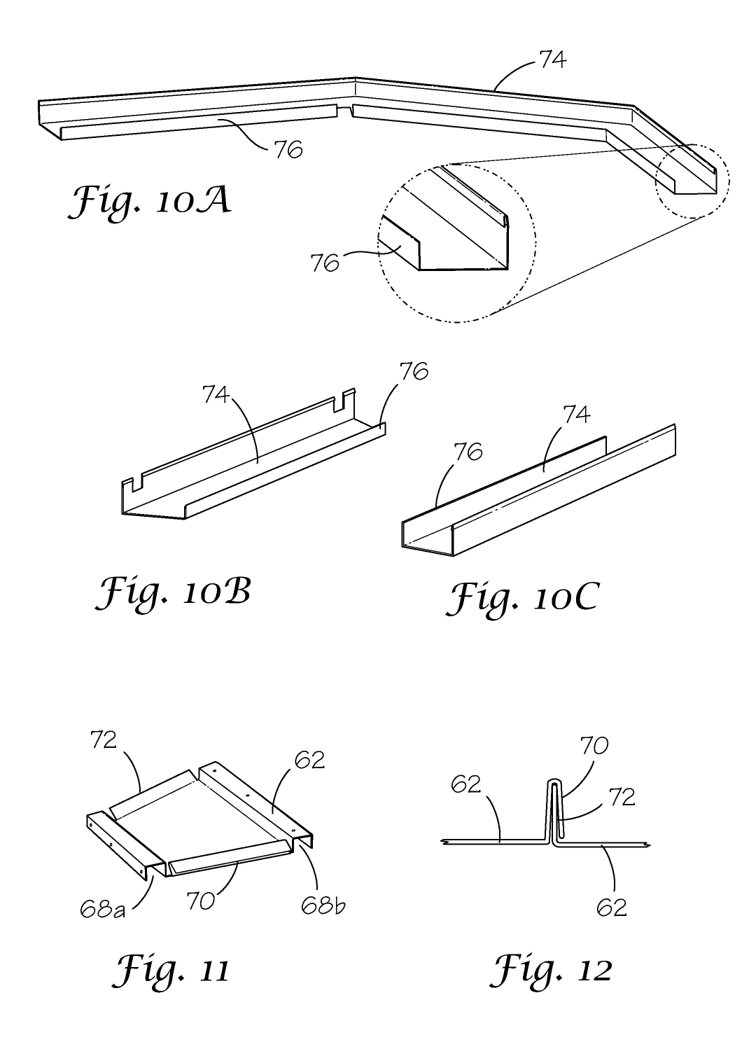

The heat deflector includes a series of lower heat trays 62 extending circumferentially around upper portion 18 of support base 10. Lower heat trays 62 extend between and are carried by an inner frame ring 64 and an outer frame ring 66. Lower heat trays 62 include a pair of frame receiving channels 68a, 68b at opposing ends for receiving the respective inner frame ring 64 and outer frame ring 66 to mount lower heat trays 62 in upper portion 18 of support base 10. As best shown in FIGS. 11 and 12, lower heat trays 62 include a securing groove 70 disposed on a first side and a connecting flange 72 on the opposing side. Accordingly, adjacent lower heat trays 62 interconnect by inserting connecting flange 72 into securing groove 70 so that each tray 62 interlocks with the adjacent lower heat trays. Additionally, as best shown in FIGS. 6A and 19, side panels 54 extend upward into frame receiving channel 68a and are disposed against frame member 16 to help hold the panels in position.

The heat deflector also includes a series of upper heat trays 74 extending circumferentially around upper portion 18 of support base 10. Upper heat trays 74 are carried by outer frame ring 66 and extend to a bottom side of counter 14 and engage heat shield 40. As best shown in FIGS. 6A and 19, upper heat trays 74 extend underneath frame members 16 defining outer frame ring 66. To secure upper heat trays 74 in position, a securing flange 76 extends upwardly into frame receiving channel 68b of lower heat trays 62 and is disposed against frame member 16. Leg panel 56 supports upper heat trays 74 from underneath to prevent upper heat trays 74 from dislodging.

While a preferred embodiment of the invention has been described using specific terms, such description is for illustrative purposes only, and it is to be understood that changes and variations may be made without departing from the spirit or scope of the following claims.

What is claimed is:

1. A griddle table comprising:
a support base defined by a plurality of connected frame members;
a griddle plate carried by said support base;
a counter carried by said support base, wherein said counter extends over top of a perimeter portion of a top side of said griddle plate, and wherein said counter is spaced above said top side of said griddle plate defining an exhaust channel between said top side of said griddle plate and a bottom side of said counter overlapping said perimeter portion of said griddle plate;
a burner unit carried by said support base disposed beneath said griddle plate for applying heat to a bottom side of said griddle plate; and,
a heat deflector carried by said support base disposed beneath and spaced apart from said griddle plate that extends upward and engages said bottom side of said counter for directing heated air into said exhaust channel;
whereby heated air is directed upward from underneath said griddle plate by said heat deflector and out through said exhaust channel for directing said heated air across said top side of said griddle plate.

2. The griddle table of claim 1 including a floor plate carried by said support base, wherein said floor plate includes a plurality of openings to promote airflow up and through said support base to exit said exhaust channel.

3. The griddle table of claim 1 including a plurality of leveling bolts carried by said support base engaging said griddle plate, wherein said leveling bolts are adjustable for varying the height at which said leveling bolts project from said support base for engaging said griddle plate to adjust the level of said griddle plate on said support base and control the size of said exhaust channel between said counter and griddle plate.

4. The griddle table of claim 3 including a bolt recess disposed in a head of each of said leveling bolts, and a plurality of retainer prongs projecting downward from said bottom side of said griddle plate, wherein each of said retainer prongs is received into a complementary shaped bolt recess of said leveling bolts so that said griddle plate is releasably secured on said support base.

5. The griddle table of claim 1 wherein said counter is pivotally connected to said support base for operating between a lowered position adjacent and extending overtop of said perimeter portion of said griddle plate, and a raised position allowing accessing to and removal of said griddle plate from said support base.

6. The griddle table of claim 5 including a securing bracket releasably securing said counter to said support base to control pivotal operation of said counter between said raised and lowered positions.

7. The griddle table of claim 6 wherein said securing bracket includes a securing arm carried by said support base, and a complementary arm receiving member carried by said counter, wherein said securing arm is received into said arm receiving member for securing said counter to said support base.

8. The griddle table of claim 7 including a locking pin extending through a continuous opening defined in said securing arm and said arm receiving member, wherein said locking pin is removable to allow separation of said securing arm from said arm receiving member to operate said counter between said raised and lowered positions.

9. The griddle table of claim 5 including a pneumatic assistant cylinder mechanism interconnecting said counter and said support base to facilitate raising and lower of said counter.

10. The griddle table of claim 1 wherein said counter fully surrounds said griddle plate for accommodating seating on all sides.

11. The griddle table of claim 1 including a heat shield disposed on said bottom side of counter along at least the portion of said counter that overlaps above said perimeter portion of said griddle plate to protect the adjacent surface of said counter from heat radiated from griddle plate 12 and passing through said exhaust channel.

12. The griddle table of claim 1 including a series of panel members surrounding support base 10 for containing and channeling heat radiating from said burner unit and said bottom side of said griddle plate upward and out said exhaust channel.

13. The griddle table of claim 1 wherein said heat deflector includes an arrangement of upper heat trays and lower heat trays carried adjacent each other on said support base and extending laterally underneath said griddle plate for channeling radiating heat upward and around said griddle plate and out through said exhaust channel across a top side of said griddle plate.

14. The griddle table of claim 13 wherein said lower heat trays are angled upwardly toward said perimeter portion of said griddle plate for channeling radiating heat toward said exhaust channel.

15. The griddle table of claim 14 wherein said upper heat trays extend generally from said lower heat trays upward to engage said bottom side of said counter so that radiating heat is directed into said exhaust channel.
